(19) United States
(12) Patent Application Publication
(10) Pub. No.: US 2020/0043349 A1
(43) Pub. Date: Feb. 6, 2020

(54) SYSTEM FOR PLOTTING FLIGHT ROUTE

(71) Applicant: AVPLAT INDIA PVT LTD, Hyderabad (IN)

(72) Inventors: Abid Mir Hussain, Kozhikode (IN); Sylvester Vijay Monie, Hyderabad (IN)

(73) Assignee: AVPLAT INDIA PVT LTD, Hyderabad (IN)

(21) Appl. No.: 16/175,869

(22) Filed: Oct. 31, 2018

(30) Foreign Application Priority Data
Aug. 2, 2018 (IN) 201841029074

(51) Int. Cl. G08G 5/00

(52) U.S. Cl. CPC G08G 5/0034; G08G 5/0026; G08G 5/0013

(57) ABSTRACT

System for plotting flight route. A system (100) is provided for plotting a flight route (396) for an aircraft. The system (100) comprises an input module (102), a server module (104), a processing module (106) and a flight route module (108). The input module (102) is configured to receive information corresponding to an aircraft, departure airport and destination airport from a user. The server module (104) is configured to determine EDTO rule-time of the aircraft, coordinates of departure and destination airports. The processing module (106) is configured to determine optimum adequate airports and optimum airways between the departure airport coordinates (302) and destination airport coordinates (304). The flight route module (108) is configured to plot a flight route (396) between the departure airport coordinates (302) and the destination airport coordinates (304) joining the list of selected waypoints on the selected airways (318, 368, 371).

### BACKGROUND

Unless otherwise indicated herein, the materials described in this section are not prior art to the claims in this application and are not admitted to being prior art by inclusion in this section.

### FIELD OF THE INVENTION

The subject matter in general relates to the field of aviation systems. More particularly, but not exclusively, the subject matter relates to automated plotting of flight route for an aircraft.

### DISCUSSION OF THE RELATED ART

Flight management in aviation includes the process of producing a flight plan to determine a proposed flight route for an aircraft. One of the important aspects of flight planning is fuel calculation to ensure safe landing of the aircraft to the destination. Flight managers would wish to minimize the flight time which needs accounting several factors. The factors such as appropriate choice of route and most importantly loading necessary fuel on board. Further, in scenarios when proposed route seems unfavourable and aircraft needs diversion to an adequate airport. Conventionally, existing flight management systems do not have a provision for determining the above discussed factors. They are computed manually by flight managers and needs accurate calculations to come with an optimized flight route. It requires numerous calculations to come up with an optimized flight route which overburdens the work of the flight managers when done manually. Accuracy of manual calculations could be challenging too.

Another aspect of the flight planning is meeting EDTO (Extended Diversion Time Operations) standards and rules. Flight planners need to consider EDTO safety rules to ensure they can reach an adequate airport if one engine fails. Plotting flight routes manually, considering the discussed scenarios is often challenging in terms of both safety and accuracy.

In light of the foregoing discussion, there is a need for an improved technique to provide a system to generate a flight route.

### SUMMARY

In an embodiment, a system is provided for plotting a flight route for an aircraft. The system comprises an input module, a server module, a processing module and a flight route module. The input module is configured to receive information corresponding to an aircraft, departure airport and destination airport from a user. The server module is configured to determine EDTO rule-time information corresponding to the aircraft, departure airport coordinates and destination airport coordinates based on the information obtained from the input module. The processing module is configured to plot an EDTO circle with the departure airport coordinates as centre, determine existing airways at the departure airport coordinates. The processing module determines airways' intersecting points on perimeter of the EDTO circle. The processing module determines a point on the perimeter of the EDTO circle, wherein the point is closest to the departure airport coordinates. The processing module plots a circle, outside the EDTO circle, such that perimeter of the circle coincides with the point determined on the perimeter of the EDTO circle, wherein radius of the circle is same as radius of the EDTO circle. The processing module determines at least one adequate airport based on predetermined criteria within a second sector. The processing module selects an adequate airport such that the selected adequate airport is the closest to the destination airport coordinates and plots an EDTO circle with adequate airport coordinates as the centre. The flight route module is configured to receive a list of waypoints between the departure airport coordinates and the destination airport coordinates from the processing module and plot a flight route between the departure airport coordinates and the destination airport coordinates joining the list of waypoints.

### BRIEF DESCRIPTION OF DIAGRAMS

This disclosure is illustrated by way of example and not limitation in the accompanying figures. Elements illustrated in the figures are not necessarily drawn to scale, in which like references indicate similar elements and in which:

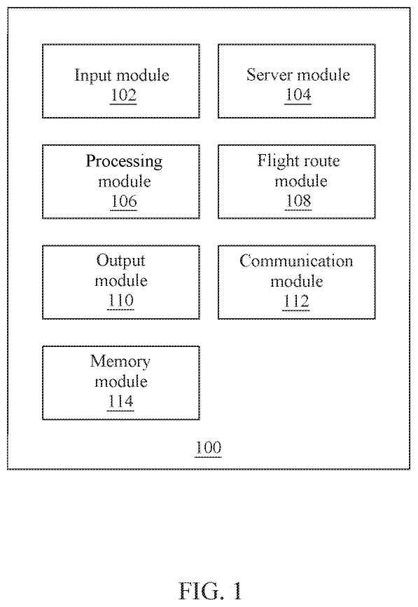

FIG. 1 illustrates a block diagram of a system 100 for plotting a flight route, in accordance with an embodiment;

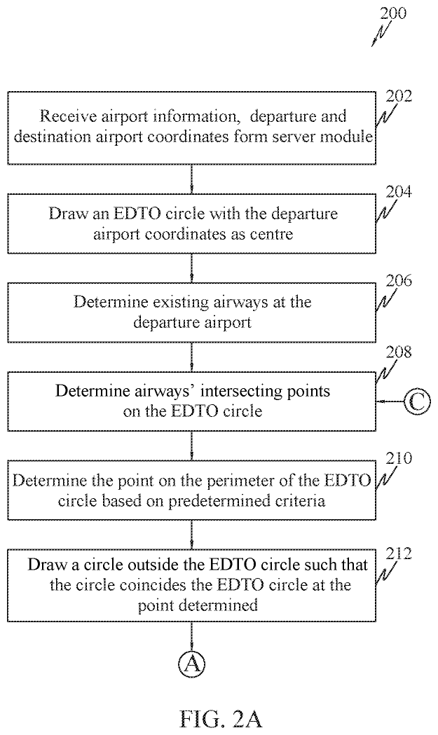

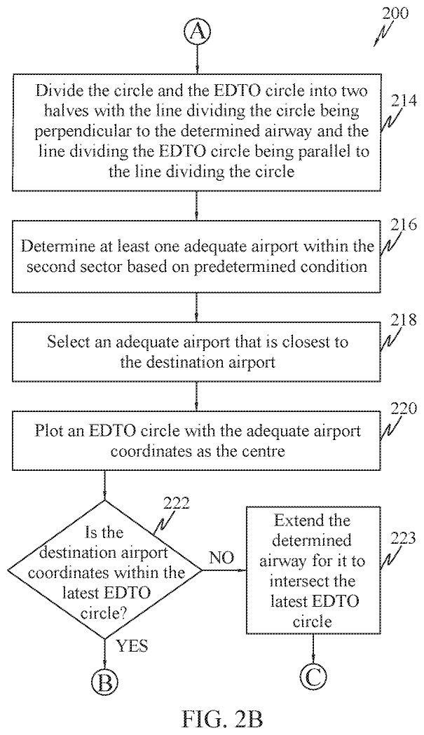

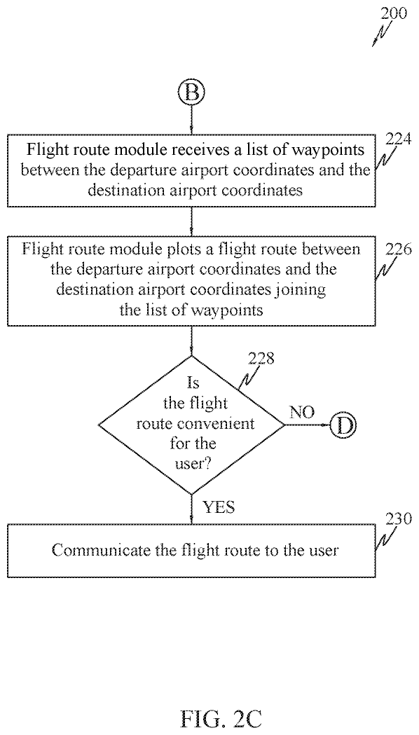

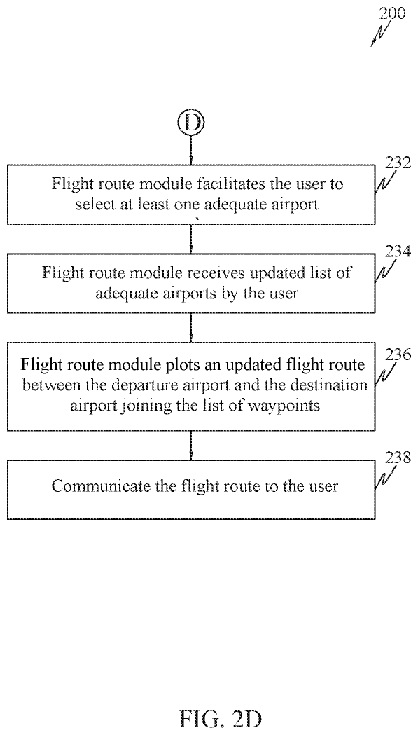

FIGS. 2A and 2B illustrate a flowchart 200 of an exemplary method of determining adequate airports and waypoints by a processing module 106 of the system 100, in accordance with an embodiment;

FIG. 2C illustrates a flowchart 200 of an exemplary method of plotting the flight route and communicating the flight route to a user, in accordance with an embodiment;

FIG. 2D illustrates a flowchart 200 of an exemplary method of facilitating the user to select adequate airports and plot the flight route, in accordance with an embodiment; and

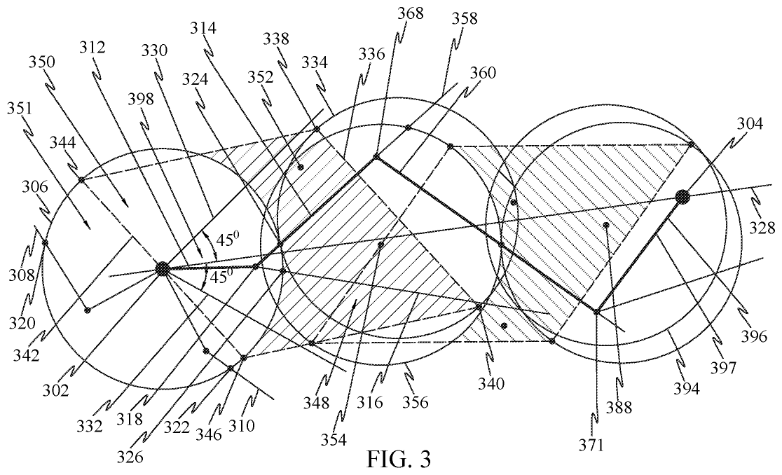

FIG. 3 illustrates a schematic representation of a flight route, determined by the system 100, in accordance with an embodiment.

### DETAILED DESCRIPTION OF THE INVENTION

The following detailed description includes references to the accompanying drawings, which form part of the detailed description. The drawings show illustrations in accordance with example embodiments. These example embodiments are described in enough details to enable those skilled in the art to practice the present subject matter. However, it may be apparent to one with ordinary skill in the art that the present invention may be practised without these specific details. In other instances, well-known methods, procedures and components have not been described in detail so as not to unnecessarily obscure aspects of the embodiments. The embodiments can be combined, other embodiments can be utilized, or structural and logical changes can be made without departing from the scope of the invention. The following detailed description is, therefore, not to be taken as a limiting sense.

In this document, the terms “a” or “an” are used, as is common in patent documents, to include one or more than one. In this document, the term “or” is used to refer to a non-exclusive “or”, such that “A or B” includes “A but not B”, “B but not A”, and “A and B”, unless otherwise indicated.

It should be understood, that the capabilities of the invention described in the present disclosure and elements shown in the figures may be implemented in various forms of hardware, firmware, software, recordable medium or combinations thereof.

Disclosed is a system 100 for determining a flight route 396. The system 100 may comprise an input module 102 for a user to input a departure airport, destination airport and aircraft information, a server module 104 configured to fetch information corresponding to aircraft and departure and destination airport coordinates 302, 304, a processing module 106 configured to determine adequate airports and waypoints, a flight route module 108 configured to plot the flight route 396 between the departure airport coordinates 302 and the destination airport coordinates 304. The processing module 106 may be configured to determine a list of adequate airports 354, 388 between the departure airport coordinates 302 and the destination airport coordinates 304. The processing module 106 may also determine a list of waypoints 318, 368, 371 between the departure airport coordinates 302 and the destination airport coordinates 304. The flight route module 108 of the system 100 may plot the flight route 396 between the departure airport coordinates 302 and the destination airport coordinates 304 joining the list of determined waypoints 318, 368, 371.

In another embodiment, the system 100 may be configured to allow the user to select an adequate airport, wherein the user would want to pass through the adequate airport on his trip from the departure airport to the destination airport. The flight route module 108 may be configured to give the user an option to select a list of adequate airports between the departure airport coordinates 302 and destination airport coordinates 304. The flight route module 108 may be configured to receive the list of adequate airports from the user. Further, the flight route module 108 may receive new list of waypoints from the processing module 106 depending upon the adequate airports.

### System for Plotting Flight Route

Referring to the figures, and more particularly to FIG. 1, a block diagram of a system 100 for plotting a flight route is provided. The system 100 may comprise an input module 102, a server module 104, a processing module 106, a flight route module 108, an output module 110, a communication module 112 and a memory module 114.

The input module 102 provides an interface for input devices such as keypad, touch screen, mouse, microphone and stylus among other input devices. The input module 102 may have a display that may be used to receive an input from a user. The display may be of any type known in the art, for example, Liquid Crystal Displays (LCD), Light emitting diode displays (LED), Cathode Ray Tube Displays (CRT), Orthogonal Liquid Crystal Displays (OLCD) or any other type of display currently existing or which may exist in the future.

The server module 104 may comprise information corresponding to list of aircrafts, airports and their coordinates. The information may vary from aircraft configuration to services available at a specific airport. The server module 104 may comprise a list of adequate airports with predefined EDTO-rule time of 60 minutes. The list may comprise another subset for EDTO-rule time information with more than 60 minutes for example 75 minutes, 90 minutes, 120 minutes, 180 minutes EDTO rule-time etc. The server module 104 may comprise ICAO/IATA, latitudes and longitudes of the airports, runway length of airports, hours of operations of aircrafts, availability of navigational aids in airports, ATC (air traffic control) services at airports, lighting system at airports, emergency services at the airports and weather reporting with ceiling and visibility forecast analysis of airports. Further, the server module 104 may also comprise weather minima for the list of adequate airports wherein the weather minima may be predefined for the list of adequate airports.

The processing module 106 is configured to determine adequate airports and waypoints between the departure and destination airports. The processing module 106 is implemented in the form of one or more processors and may be implemented as appropriate in hardware, computer-executable instructions, firmware, or combinations thereof. Computer-executable instruction or firmware implementations of the processing module 106 may include computer-executable or machine-executable instructions written in any suitable programming language to perform the various functions described.

The flight route module 108 is configured to plot the flight route for a given departure and destination airports and generate the flight route.

The output module 110 may provide an interface for output devices such as display screen, speakers, printer and haptic feedback devices, among others. The output module 110 may be configured to display flight route. The output module 110 may have a display of any type known in the art, for example, Liquid Crystal Displays (LCD), Light emitting diode displays (LED), Cathode Ray Tube Displays (CRT), Orthogonal Liquid Crystal Displays (OLCD) or any other type of display currently existing or which may exist in the future.

The communication module 112 may be used by different modules of the system 100 to communicate with each other. The communication module 112, as an example, may be a GPRS module, or other modules that enable telecommunication. The communication module 112 may include a modem, a network interface card (such as Ethernet card), a communication port, or a Personal Computer Memory Card International Association (PCMCIA) slot, among others. The communication module 112 may include devices supporting both wired and wireless protocols. Data in the form of electronic, electromagnetic, optical, among other signals may be transferred via the communication module 112.

The memory module 114 may include a permanent memory such as hard disk drive, may be configured to store data, and executable program instructions that are implemented by the processing module 106. The memory module 114 may be implemented in the form of a primary and a secondary memory. The memory module 114 may store additional data and program instructions that are loadable and executable on the processing module 106, as well as data generated during the execution of these programs. Further, the memory module 114 may be volatile memory, such as random-access memory and/or a disk drive, or non-volatile memory. The memory module 114 may comprise of removable memory such as a Compact Flash card, Memory Stick, Smart Media, Multimedia Card, Secure Digital memory, or any other memory storage that exists currently or may exist in the future.

Referring to the FIGS. 2A and 2B, a flowchart 200 is provided to determine adequate airports and waypoints between the departure airport and the destination airport. Now referring to step 202, a user inputs aircraft information, departure airport and destination airport using an input module 102. In an embodiment, aircraft information may correspond to the type of aircraft, fuel capacity of the aircraft, range of the aircraft, weight of the aircraft and other aircraft related information. Further, the input module 102 may be configured to obtain information corresponding to services the user may wish to avail at an airport. The services may relate to parking fee for the aircraft, passenger facilities such as restaurants, lounge access, internet facilities and emergency services, health and medical etc. In an embodiment, the input module 102 may provide the user an option to choose the destination and departure airports from a list of airports.

Referring to the step 204, the processing module 106 may receive information corresponding to aircraft, departure and destination airports from the input module 102 using the communication module 112. The processing module 106 may communicate information obtained from the input module 102 to the server module 104. In an embodiment, the input module 102 may communicate the information obtained from the user directly to the server module 104. Once the server module 104 receives information inputted from the user, it may be configured to determine an EDTO rule-time information of the aircraft, departure airport coordinates and destination airport coordinates. EDTO rule-time information may correspond to a maximum time the two-engine aircraft can fly, within the nearest adequate airport, with one engine operative. EDTO rule-time for aircrafts may vary depending upon the type of aircraft. i.e. the EDTO rule-time can be 60 minutes, 120 minutes, 180 minutes, 240 minutes etc. The server module 104 may comprise these EDTO rule-time information for different aircrafts. The server module 104 may further comprise a list of coordinates of all the airports around the world.

In an embodiment, the server module 104 upon extracting the EDTO rule-time for the aircraft inputted by the user and the coordinates of the departure and destination airport, may communicate it to the processing module 106.

At step 204 and referring to FIG. 3, the processing module 106 may draw an EDTO circle 306 with the departure airport coordinates 302 as centre. At step 206, the processing module 106 may determine the airways 308, 310, 312 that may exist at the departure airport coordinates 302. Airways are fixed paths in space through which the aircraft has to pass through. In an embodiment, the airway 312 may split into two airways 314 and 316 at a waypoint 318. Waypoints are fixed points in space through which an aircraft has to enter or exit an airway.

At step 208 and referring to FIG. 3, the processing module 106 may be configured to determine the points 320, 322, 324, 326 on the EDTO circle 306 where the airways 308, 310, 314, 316 intersect the perimeter of the EDTO circle 306.

In an embodiment, the processing module may plot a great circle track 328 between the departure airport coordinates 302 and the destination airport coordinates 304. The great circle track 328 may be the shortest path between the departure airport and the destination airport.

At step 210 and referring to FIG. 3, the processing module 106 may determine the point 324 on the perimeter of the EDTO circle 306 based on predetermined criteria.

In an embodiment, the predetermined criteria may correspond to the determined point 324 being the closest to the destination airport coordinates 304, when compared to the other points 320, 322, 326.

In another embodiment, the predetermined criteria may correspond to the determined point 324 being within a quadrant 398, wherein the quadrant 398 is obtained by plotting a line 330 that maybe offset 45° anti clockwise from the great circle track 328 and plotting another line 332 that maybe offset 45° clockwise from the great circle track 328.

In another embodiment, the predetermined criteria may correspond to the determined point 324 being the closest to the great circle track 328, when compared to the other points 320, 322, 326.

In another embodiment, the processing module 106 may determine the airway 314 of the corresponding point 324.

Referring to step 212 and referring to FIG. 3, the processing module 106 may draw a circle 334, the radius of which is same as that of the EDTO circle 306, outside the EDTO circle 306 such that the circle 334 coincides the EDTO circle 306 at the point 324.

At step 214 and referring to FIG. 3, the processing module 106 may divide the circle 334 into two halves using a line 336. In an embodiment, the line 336 dividing the circle 334 into two halves may be perpendicular to the determined airway 314 and may pass through the centre of the circle 334. The processing module 106 may determine points 338, 340 where the line 336 intersects the circle 334. In an embodiment, the processing module 106 may divide the EDTO circle 306, into first half 351 and second half 350 using a line 342, where the line 342 may be parallel to the line 336. The processing module 106 may determine points 344, 346 where the line 342 intersects the EDTO circle 306.

In an embodiment, the processing module 106 may join the point 338 on the circle 334 with the point 344 on the EDTO circle 306 and the point 340 on the circle 334 with the point 346 on the EDTO circle 306 to form a first sector.

In an embodiment, the processing module 106 may determine a second sector 348 by excluding the area covered by the second half circle 350 of the EDTO circle 306 from the first sector.

At step 216 and referring to FIG. 3, the processing module 106 may determine all the adequate airports within the second sector 348, based on predetermined criteria. The predetermined criteria may correspond to 24 hours availability of the adequate airports, availability of minimum runaway length requirement for the aircraft, availability of additional services such as ATC, lighting system, communication systems, weather reporting, emergency services and availability of navaids such as ILS, VOR or NDB at the adequate airports. It may be noted that minimum length for the aircraft may be predefined by the personal operating the system 100 which may be obtained by the server module 104. In an embodiment, the processing module 106 may determine adequate airports 352, 354 based on the predetermined criteria.

At step 218, the processing module 106 may select an adequate airport 354, among the determined adequate airports 352, 354 based on predetermined criteria. In an embodiment, the predetermined criteria may be that the adequate airport 354 be the closest to the destination airport coordinates 304.

In an embodiment, the predetermined criteria may be that the adequate airport 354 be the closest to the line 336 dividing the circle 334. In another embodiment, the criteria may be that the adequate airport 354 be the closest to the determined airway 314.

Referring to step 220 and FIG. 3, the processing module 106 may be configured to plot an EDTO circle 356 with the coordinates of the adequate airport 354 as the centre.

At step 222, the processing module 106 may determine whether the destination airport coordinates 304 are within the latest EDTO circle 356. If the destination airport coordinates 304 are not within the latest EDTO circle 356, at step 223, the processing module 106 may extend the determined airway 314 to intersect the EDTO circle 356 and the processing module 106 may follow the steps from 208 to 222 till the destination airport coordinates 304 are within the latest EDTO circle. As an example, referring to FIG. 3, the destination airport coordinates 304, at step 222, were not found to be within the latest EDTO circle 356. Therefore, the processing module 106 carries out steps 223 and 208-222, that is the processing module 106 determines that the airway 314 splits into two airways 358 and 360 at waypoint 368 and may determine adequate airport 388 and their corresponding EDTO circle 394. Also, the processing module 106 may determine that the airway 360 may deviate at waypoint 371 into airway 397. As the destination airport coordinates 304 falls within the EDTO circle 394, the processing module 106 follows step 224.

Referring to the FIG. 2C, a flowchart 200 is provided to determine and plot the flight route. Now referring to the step 224 and FIG. 3, the flight route module 108 may receive the list of waypoints 318, 368, 371 between the departure airport coordinates 302 and the destination airport coordinates 304 from the processing module 106.

At step 226, the flight route module 108 may be configured to plot a flight route 396 between the departure airport coordinates 302 and the destination airport coordinates 304 joining the list of waypoints 318, 368, 371.

Referring to step 228, the flight route module 108 may be configured to verify whether the flight route 396 is convenient to the user, by providing an option for the user to make changes to the flight route 396. For example, the user, on the way from the departure airport to destination airport, would want to halt at an adequate airport due to some reason. In a scenario like this, the system 100 may be able to facilitate the user to modify the flight route 396 to comply with the user requirement.

In an embodiment, the flight route module 108 may be configured to display the flight route 396 to the user using the output module 110. In yet another embodiment, the flight route module 108 may be configured to display a list of all the adequate airports 352, 354 that were considered to determine the adequate airport 354 closest to the destination airport, for a given circle 334.

If the user chooses to make changes to the flight route 396, the flight route module 108 may facilitate the user to make appropriate changes and is explained in FIG. 2D of flowchart 200.

If the user chooses not to make any changes to the flight route 396, the flight route module 108 may communicate the flight route 396 to the user (step 230).

In an embodiment, if the server module 104 does not determine the flight to be EDTO or NON-EDTO, the flight route module 108 may be configured to determine the shortest flight time between the destination and the departure airports.

FIG. 2D is a flowchart 200 for facilitating the user to make appropriate changes to the flight route 396. At step 232, the flight route module 108 may be configured to facilitate the user to select at least one adequate airport of his/her choice. Referring to FIG. 3, the circle 334 may comprise a plurality of adequate airports 352, 354 among which the adequate airport 354 was selected by the processing module 106. In some scenarios, wherein, the user may find the adequate airport 352 to be convenient due to personal requirement, the flight route module 108 may provide the user an option to select the convenient adequate airport 352.

Referring to the step 234, the flight route module 108 may be configured to receive a list of adequate airports by the user. At step 236, the flight route module 108 may communicate the same to the processing module 106 to get an updated list of waypoints and may plot an updated flight route. At step 238, the flight route module 108 may communicate the updated flight route to the user.

In an embodiment, the flight route module 108, upon allowing the user to select an adequate airport of his/her choice, may further provide an option for the user to select from the list of services the user may make use of, at the adequate airport.

The processes described above is described as a sequence of steps, this was done solely for the sake of illustration. Accordingly, it is contemplated that some steps may be added, some steps may be omitted, the order of the steps may be re-arranged, or some steps may be performed simultaneously.

The example embodiments described herein may be implemented in an operating environment comprising software installed on a computer, in hardware, or in a combination of software and hardware.

Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

Many alterations and modifications of the present invention will no doubt become apparent to a person of ordinary skill in the art after having read the foregoing description. It is to be understood that the phraseology or terminology employed herein is for the purpose of description and not of limitation. It is to be understood that the description above contains many specifications, these should not be construed as limiting the scope of the invention but as merely providing illustrations of some of the personally preferred embodiments of this invention.

What is claimed is:

1. A system (100) for plotting a flight route (396) for an aircraft, the system (100) comprising:
an input module (102) configured to receive information corresponding to an aircraft, departure airport and destination airport from a user;
a server module (104) configured to determine EDTO rule-time information corresponding to the aircraft, departure airport coordinates (302) and destination airport coordinates (304) based on the information obtained from the input module (102);
a processing module (106) configured to:
plot an EDTO circle (306) with the departure airport coordinates (302) as centre;
determine existing airways (308, 310, 312) at the departure airport coordinates (302);
determine airways' (308, 310, 314, 316) intersecting points (320, 322, 324, 326) on perimeter of the EDTO circle (306);
determine a point (324) on the perimeter of the EDTO circle (306), based on predetermined criteria;
determine airway (314) corresponding to the determined point (324);
plot a circle (334), outside the EDTO circle (306), such that perimeter of the circle (334) coincides with the point (324) determined on the perimeter of the EDTO circle (306), wherein radius of the circle (334) is same as radius of the EDTO circle (306);
determine at least one adequate airport (352, 354) based on predetermined criteria within a second sector (348);
select an adequate airport (354) such that the selected adequate airport (354) is the closest to the destination airport coordinates (304);
plot an EDTO circle (356) with adequate airport coordinates (354) as the centre;
a flight route module (108) configured to:
receive a list of waypoints (318, 368, 371) between the departure airport coordinates (302) and the destination airport coordinates (304) from the processing module (106); and
plot a flight route (396) between the departure airport coordinates (302) and the destination airport coordinates (304) joining the list of waypoints (318, 368, 371).

2. The system (100) according to claim 1, wherein the aircraft information corresponds to fuel capacity of the aircraft, range of the aircraft and weight of the aircraft.

3. The system (100) according to claim 1, wherein the input module (102) is configured to receive information corresponding to services the user will avail at an airport.

4. The system (100) according to claim 1, wherein the server module (104) comprises a list of airport coordinates.

5. The system (100) according to claim 1, wherein the server module (104) comprises EDTO rule-time information for different aircrafts.

6. The system (100) according to claim 1, wherein the predetermined criteria to determine a point (324) on the perimeter of the EDTO circle (306) corresponds to at least one of, the point (324) being closest to the destination airport coordinates (304), the point (324) being within a quadrant which is 45 degrees offset on either side of great circle track (328), or the point (324) being closest to the great circle track (328).

7. The system (100) according to claim 1, wherein the great circle track (328) is the shortest path between the departure airport and the destination airport.

8. The system (100) according to claim 1, wherein the processing module (106) is configured to:
divide the circle (334) into two halves, wherein line (336) dividing the circle (334) into two halves is perpendicular to the airway (314) and passes through the centre of the circle (334);
determine points (338, 340) on the perimeter of the circle (334) where the line (336) intersects the circle (334);
divide the EDTO circle (306) into first half (351) and second half (350), wherein line (342) dividing the EDTO circle (306) is parallel to the line (336) dividing the circle (334); and
determine points (344, 346) on the perimeter of the EDTO circle (306) where the line (342) intersects the EDTO circle (306).

9. The system (100) according to claim 8, wherein the processing module (106) is configured to join the point (338) on the perimeter of the circle (334) with the point (344) on the perimeter of the EDTO circle (306) and the point (340) on the perimeter of the circle (334) with the point (346) on the perimeter of the EDTO circle (306) to form a first sector.

10. The system (100) according to claim 9, wherein the second sector (348) is obtained by excluding area covered by the second half (350) of the EDTO circle (306) from the first sector.

11. The system (100) according to claim 1, wherein the predetermined criteria to determine at least one adequate airport (352, 354) corresponds to at least one of, availability of the adequate airports (352, 354), or minimum runaway length requirement for the aircraft at the adequate airports (352, 354).

12. The system (100) according to claim 1, wherein the processing module (106) plots the EDTO circles (356, 394) and determines the adequate airports (354, 388) until the destination airport coordinates (304) coincides or is within the EDTO circle (394) of the latest adequate airport (388).

13. The system (100) according to claim 1, wherein the flight route module (108) is configured to facilitate the user to select at least one adequate airport.

14. The system (100) according to claim 13, wherein the flight route module (108) is configured to communicate the at least one adequate airport to the processing module (106).

15. The system (100) according to claim 14, wherein the processing module (106) is configured to determine waypoints and communicate the waypoints to the flight route module (106).

16. The system according to claim 15, wherein the flight route module (108) is configured to plot a flight route (396) between the departure airport coordinates (302) and the destination airport coordinates (304) joining the waypoints.
